(19) United States
(12) Patent Application Publication
(10) Pub. No.: US 2026/0287720 A1
(43) Pub. Date: Sep. 24, 2026

(54) INDOOR LIDAR PLENOPTIC SENSOR ARRAY BASED ON TIME-OF-FLIGHT REFLECTION

(71) Applicant: UNM RAINFOREST INNOVATIONS, Albuquerque, NM (US)

(72) Inventors: Steven R.J. BRUECK, Albuquerque, NM (US); Payman ZARKESH-HA, Albuquerque, NM (US); Alexander NEUMANN, Albuquerque, NM (US)

(21) Appl. No.: 19/071,938

(22) Filed: Mar. 6, 2025

Related U.S. Application Data
(60) Provisional application No. 63/562,396, filed on Mar. 7, 2024.

(51) Int. Cl. G01S 7/481; G01S 7/486; G01S 7/4861; G01S 7/4865; G01S 7/4912; G01S 7/4913; G01S 7/4915; G01S 7/499

(52) U.S. Cl. CPC G01S 7/4816; G01S 7/4861; G01S 7/4865; G01S 7/4868; G01S 7/4913; G01S 7/4915; G01S 7/4918; G01S 7/499

(57) ABSTRACT

A time-of-flight (ToF) sensor integrated on a Si substrate based on a periodic-structure-coupled waveguide propagation and detection to provide immunity from ambient light is disclosed. The ToF sensor includes one or more optical sources to illuminate a region of interest; one or more periodic-structure-coupled waveguides to collect light reflected from objects within the region of interest and propagating in a narrowband of altitude and azimuth (θ, φ) angles determined by one or more parameters of the periodic-structure-coupled waveguides; a photon detector integrated with each periodic-structure-coupled waveguide to provide an electrical current proportional to the light coupled into the periodic structure-coupled waveguide; shielding incorporated into metal interconnect layers of the integrated ToF sensor to shield the detectors from direct illumination; and a first electronics comprising a transimpedance amplifier (TIA) to amplify the electrical current and interface with a second electronics that provides ToF information for each detector.

### CROSS REFERENCE TO RELATED APPLICATIONS

This application claims benefit to Provisional Patent Application Ser. No. 63/562,396 filed on Mar. 7, 2024, the contents of which are hereby incorporated by reference in its entirety.

### STATEMENT OF GOVERNMENT INTEREST

This invention was made with government support under Grant DE-AR0000942 awarded by the Department of Energy's Advanced Research Projects Agency-Energy (ARPA-E). The government has certain rights in the invention.

### FIELD

The present teachings relate generally to a lidar plenoptic array sensor and, more particularly, to an indoor lidar plenoptic sensor array based on time-of-flight reflection.

### BACKGROUND

Improved energy efficiency and the associated cost savings are useful for environmental stewardship. In heating, ventilation, and cooling (HVAC) systems, occupancy sensors play a role in system control for energy conservation. There is increasing interest in 3D optical measurements (azimuth, altitude and range) for applications ranging from automotive lidar, to manufacturing processes, occupancy detection, and healthcare. System requirements including: range; resolution; field-of-view; ambient light rejection; multi-target array detection capability; power consumption; and eye safety vary across these applications. In general, time of flight distance sensors consist of a light source and a photodetector. For indoor monitoring, with applications to HVAC control (occupancy monitoring) and healthcare applications, for example nursing home patient monitoring, privacy concerns often preclude imaging solutions. Spectroscopy is a related area of application for integrated lab-on-a-chip sensors.

One way to accomplish occupancy detection while maintaining personal privacy is to use ToF sensors. In general, ToF sensors consist of a light source and a light detector. The light source can be a laser emitting a pulsed or a continuous-wave signal. When this signal illuminates an object, some of that light is scattered back towards the detector. The ToF sensor measures the time for the transmitted light signal to return to the detector, providing a distance measurement. Adding an array of detectors with specific angular acceptance provides a 3D capability, giving the distance to objects and their orientation relative to the sensor. This is not a stereoscopic measurement and is independent of the separation between array elements, allowing detection across many angles in a compact arrangement suitable for integrated circuit manufacturing processes.

Building occupancy monitoring is an important application that could lead to substantial reductions in HVAC energy usage and play an important role in environmental stewardship. Clearly cost considerations require monitoring of wide areas with ToF sensor arrays. Integrated photonic optical sensors, compatible with high volume silicon integrated circuit manufacturing, are essential for reaching system cost goals and widespread adoption. A significant issue for currently available ToF sensors is interference between the ToF signal and room illumination (both natural (sunlight) and artificial illumination). Most commercial ToF systems are based on direct detection of retroreflected illumination using broadband single photon avalanche detectors (SPADs). Spectral filters help in rejecting room illumination, but are still relatively broadband posing a significant interference issue.

For people counting in buildings, the laser wavelength is chosen in the near infrared beyond the range of the human visual system. For the results presented here, a wavelength of 940 nm is assumed. Inexpensive, vertical-cavity lasers are available at this wavelength, Si is relatively low absorption and can be used as the waveguide core for short propagation distances, and Ge is a sensitive (high absorption) detector material that is compatible with Si-based integrated circuit manufacturing.

Detection of the positions and motions of objects in the local environment is also of great importance for applications such as lidar for driving assistance and for self-driving vehicles. In this application, the distances are much greater, <~100 m, the required resolution is comparable, the issues of ambient light rejection are more difficult, and the reliability of the measurement is more critical.

### SUMMARY

According to examples of the present disclosure, an integrated plenoptic device/people occupancy counting sensor for time-of-flight (ToF) measurements based on grating-coupled-waveguides, providing angularly resolved detection in a compact form factor is disclosed. Light from a laser source is scattered from objects up to 5 m distant. The acceptance angle for scattered light is determined by the period of the detector grating and the waveguide properties. As a consequence of the narrow-band angular optical coupling, the plenoptic sensor demonstrates a good immunity to background light sources, such as sunlight and incandescent room illumination. The conical acceptance angles (azimuth and altitude) of this device are measured and confirm the device model. The device can be realized on a commercial silicon-based integrated-photonics foundry line, providing a pathway to volume manufacturing.

According to examples of the present disclosure, a ToF sensor based on grating-coupled waveguide propagation and detection that provides immunity from ambient light. The ToF sensor comprises one or more optical sources to illuminate a region of interest, one or more grating-coupled waveguides to collect light reflected from objects within the region of interest and propagating in a narrowband of altitude (θ) angles determined by the grating coupling parameters, one or more photon detectors integrated with the waveguides to provide an electrical current proportional to the light coupled into each waveguide, shielding to prevent direct illumination of the photon detector so that it is sensitive only to light coupled into the waveguide, and electronics including a transimpedance amplifier (TIA) to amplify the electrical current and interface with following electronics that provide ToF information.

There are two general formats for ToF sensors: 1) direct, based on the time delay between a probing pulse and its retroreflection, and 2) indirect, based on the retroreflected phase shift of a continuous-wave amplitude-modulated signal. For occupancy sensors, the relevant distances are dependent on room size (particularly ceiling height) and the required resolution is ~¼ m. For a 3 m ceiling height (~9′) the return time from a 2 m (~6′) tall person is ~7 ns and the required temporal resolution is about 0.8 ns, which sets requirements on the frequency response of the detection for direct formats at ~1 GHz. For amplitude modulated formats, the required frequency response is more relaxed. Since the phase shift can be measured to ~1000^{th} of a wavelength, this puts the modulation frequency as >~15 MHz, easing the required complexity of the electronics implementation.

Various additional features can be included in the ToF sensor including one or more of the following features: the source can be amplitude modulated and the following electronics provides information on the phase shift between the source modulation and the reflected light to extract ToF information; the source can comprise two orthogonally polarized sources modulated at different frequencies to provide additional information on the relative contributions of TE and TM coupling; the source can be pulse modulated and the following electronics provides information on the time delay between the source pulse and the arrival of the reflected light to extract ToF information; the source can be raster scanned in one direction, e.g. a line of illumination, and the detector can be configured to sense retroreflections in the orthogonal direction; the angular acceptance of the grating coupled waveguide can be restricted by segmenting the broad area waveguide into parallel waveguides; the photon detector can be a semiconductor detector integrated into the waveguide; the photon detector can be a PIN detector or an APD detector; and the photon detector can comprise one of Si, Ge, InAsP or other III-V alloy.

According to examples of the present disclosure, a time-of-flight (ToF) system is disclosed that comprises an array of waveguide coupled ToF detectors with different grating orientations and periods to provide ToF coverage over a large area. In some examples, the arrangement of the TOF system is arranged to suppress the propagation of modes coupled from conical diffraction. In one example, this can be accomplished by dividing the planar waveguide into groups of 2D waveguides by, for example, segmenting the planar waveguide to a number of parallel waveguides in the collection area up to the detector area. In some examples, the planar waveguide can have a 2D (XY) profile such that the transverse electric (TE) mode, where there is no electric field component along the direction of propagation, and the transverse magnetic (TM) mode, where there is no magnetic field component along the direction of propagation, have the same propagation index, such that there is no ambiguity in the TE and TM response. In another example, this can be accomplished by using a structured (2D- or Bragg-) coupling grating over the collection area. The Bragg grating can be arranged such that it forbids all conical modes except the desired one.

According to examples of the present disclosure, a time-of-flight (ToF) sensor integrated on a Si substrate based on a periodic-structure-coupled waveguide propagation and detection to provide immunity from ambient light is disclosed. The ToF sensor comprises one or more optical sources to illuminate a region of interest; one or more periodic-structure-coupled waveguides to collect light reflected from objects within the region of interest and propagating in a narrowband of altitude and azimuth (θ, φ) angles determined by one or more parameters of the periodic-structure-coupled waveguides; a photon detector integrated with each periodic-structure-coupled waveguide to provide an electrical current proportional to the light coupled into the periodic structure-coupled waveguide; shielding incorporated into metal interconnect layers of the integrated ToF sensor to shield the detectors from direct illumination; and a first electronics comprising a transimpedance amplifier (TIA) to amplify the electrical current and interface with a second electronics that provides ToF information for each detector.

Various additional features can be included in the ToF sensor including one or more of the following features. Each periodic-structure-coupled waveguide is a broad area waveguide extending across the collection area. Each periodic-structure-coupled waveguide is partitioned into a parallel array of narrower waveguides. Each of the one or more optical sources are amplitude modulated and the second electronics provides information on a phase shift between a source modulation and reflected light to extract the ToF information. Each of the one or more optical sources comprises two orthogonally polarized sources modulated at different frequencies to provide additional identification based on the relative strengths of TE and TM coupling. Each of the one or more optical sources are pulse modulated. The second electronics provides information on a time delay between source pulse and arrival of reflected light to extract the ToF information. Each of the one or more optical sources comprises two orthogonally polarized sources pulsed at different times to provide additional identification based on the relative strengths of TE and TM coupling. The photon detector is a semiconductor detector integrated with the periodic-structure-coupled waveguide. The photon detector comprises a PIN detector or an avalanche photodiode (APD) detector. The photon detector comprises Si, Ge, InAsP, or ternary or quaternary III-V alloy (including various combinations of group III and group V elements). The source is configured to illuminate a line and sweep the line across a field of view and the periodic-structure-coupled waveguides are configured collect light reflected from objects within the region of interest in a narrowband of altitude and azimuth (θ, φ) angles determined by one or more parameters of the periodic-structure-coupled waveguides where the narrowband altitude and azimuth angles are oriented to collect reflected light along a line perpendicular to the illumination. Splitting the spatial resolution between the source and the detection allows for lessening the requirements on both.

According to examples of the present disclosure, a time-of-flight (ToF) sensor based on grating-coupled waveguide propagation and detection to provide immunity from ambient light is disclosed. The ToF sensor comprises one or more optical sources to illuminate a region of interest; one or more silicon-on-insulator (SOI) grating-coupled waveguides to collect light reflected from objects within the region of interest and propagating in a narrowband of altitude and azimuth (θ, φ) angles determined by one or more coupling parameters of the periodic-structure-coupled waveguide; a germanium photon detector integrated with each periodic-structure-coupled waveguide to provide an electrical current proportional to the light coupled into the periodic-structure-coupled waveguide; a transimpedance amplifier (TIA) that amplifies the electrical current and interface with electronics that provides ToF information; and metal shields that prevent direct illumination of each detector.

According to another example of the present disclosure, the position determination can be shared between the illumination and the detection. In place of illumination of the entire field of view, a narrower line of illumination can be scanned across a scene and the detector array can be configured to provide information in the orthogonal direction.

Various additional features can be included in the ToF sensor including one or more of the following features. Each SOI periodic-structure-coupled waveguide comprises a substrate layer, a SiO₂ layer formed on to a top surface of the substrate layer, a Si waveguide layer formed on a top surface of the SiO₂ layer, a SiO₂ cladding layer atop the Si waveguide layer, a polycrystalline silicon periodic structure formed on a top surface of the Si waveguide layer, and additional dielectric layers above the periodic structure with a line-of-sight path from the top of the ToF sensor to the periodic-coupling structure. The periodic structure formed on a top. Each of the one or more optical sources are amplitude modulated and the second electronics provides information on a phase shift between a source modulation and reflected light to extract the ToF information. Each of the one or more optical sources comprises two orthogonally polarized sources modulated at different frequencies to provide additional identification based on the relative strengths of TE and TM coupling. Each of the one or more optical sources are pulse modulated. The electronics provides information on a time delay between source pulse and arrival of reflected light to extract the ToF information. Each of the one or more optical sources comprises two orthogonally polarized sources pulsed at different times to provide additional identification based on the relative strengths of TE and TM coupling. The germanium photon detector is a semiconductor detector integrated into the SOI grating-coupled waveguide. The germanium photon detector comprises a PIN detector or an avalanche photodiode (APD) detector.

According to examples of the present disclosure, a method of measurement and/or detection using a time-of-flight (ToF) sensor integrated on a Si substrate based on a periodic-structure-coupled waveguide propagation and detection to provide immunity from ambient light is disclosed. The method comprises using one or more optical sources to illuminate a region of interest; using one or more periodic-structure-coupled waveguides to collect light reflected from objects within the region of interest and propagating in a narrowband of altitude and azimuth (θ, φ) angles determined by one or more parameters of the periodic-structure-coupled waveguides; detecting using a photon detector integrated with each periodic-structure-coupled waveguide to provide an electrical current proportional to the light coupled into the periodic structure-coupled waveguide; shielding incorporated into metal interconnect layers of the integrated ToF sensor to shield the detectors from direct illumination; and amplifying using a first electronics comprising a transimpedance amplifier (TIA) the electrical current and interface with a second electronics that provides ToF information for each detector.

According to examples of the present disclosure, a method of measurement and/or detection using a time-of-flight (ToF) sensor based on grating-coupled waveguide propagation and detection to provide immunity from ambient light is disclosed. The method comprises using one or more optical sources to illuminate a region of interest; using one or more silicon-on-insulator (SOI) grating-coupled waveguides to collect light reflected from objects within the region of interest and propagating in a narrowband of altitude and azimuth (θ, φ) angles determined by one or more coupling parameters of the periodic-structure-coupled waveguide; detecting using a germanium photon detector integrated with each periodic-structure-coupled waveguide to provide an electrical current proportional to the light coupled into the periodic-structure-coupled waveguide; using a transimpedance amplifier (TIA) that amplifies the electrical current and interface with electronics that provides ToF information; and shielding using metal shields that prevent direct illumination of each detector. According to another example of the present disclosure, in the method, the position determination can be shared between the illumination and the detection. In place of illumination of the entire field of view, a narrower line of illumination can be scanned across a scene and the detector array can be configured to provide information in the orthogonal direction.

It is to be understood that both the foregoing general description and the following detailed description are exemplary and explanatory only and are not restrictive of the present teachings, as claimed.

### BRIEF DESCRIPTION OF THE FIGURES

The accompanying drawings, which are incorporated in and constitute a part of this specification, illustrate aspects of the present teachings and together with the description, serve to explain the principles of the present teachings.

FIG. 1 shows a plenoptic sensor array according to examples of the present disclosure. A source on the ceiling illuminates a cone, time-of-flight of reflected light is detected at multiple angles to provide a coarse 3D mapping. For simplicity of depiction, the azimuth φ=0 in the figure.

FIG. 2A shows top view and a side schematics of the plenoptic device based on a silicon-on-insulator (SOI) waveguide clad with SiO₂, a polycrystalline or poly-Si grating structure and a Ge photodetector according to examples of the present disclosure. The length of the grating coupling region is L_{g} and the width is L_{w}.

FIG. 2B shows end on views from the middle of the waveguide region toward the detector showing either a slab waveguide, L_{w}>>λ/n_{c} or a series of parallel low-order mode waveguides, L_{sw}~λ/n_{c} and separation Lₛₛ where n_{c} is the refractive index of the core waveguide material (Si) and L_{sw} is the width of the individual waveguides according to examples of the present disclosure.

FIG. 2C shows a side view schematic of the plenoptic device with a multi-layer photonic crystal coupling structure in place of the simple grating of FIG. 2A.

FIG. 3A, FIG. 3B, and FIG. 3C show simulation result of coupling length and angular intensity in FIG. 3A, for TE in FIG. 3B, and TM mode coupling in FIG. 3C, according to examples of the present disclosure. For these simulations, the waveguide width L_{w} was 100 nm>>λ/n_{c}, e.g. a slab waveguide. FIG. 3A shows the decay of the signal power in the waveguide as a function of propagation length for a signal initiated at the start of the grating. The collection area length was 250 μm, sufficiently long that the angular width is inversely proportional to the coupling length. The 250 μm TE mode collection length is more than 10× the simulated coupling length, so the resolution is dominated by L_{c}. The angular resolution of the TM mode is narrower than that for the TE mode consistent with the longer L_{c}; there is some contribution to the angular resolution from the finite grating dimension (L_{g}) as well as from the coupling length.

FIG. 4 shows an experimental setup for the angular scan according to examples of the present disclosure.

FIG. 5A and FIG. 5B shows the φ=0 measurement of the (a) TE and (b) TM mode coupling angles with a 500 nm period poly-Si grating and a thinned SOI waveguide with the detector at 0 V bias according to examples of the present disclosure. The grating width L_{w} (along the grating lines) was 100 μm and the power density incident on the chip before coupling was 26 μW/mm².

FIG. 6A and FIG. 6B show TM angular response for conical geometry and photocurrent variation with azimuthal angle, respectively, according to examples of the present disclosure.

FIG. 7 shows signal variation without and with incandescent light irradiation according to examples of the present disclosure.

FIG. 8 shows a test setup using indirect ToF measurement using the developed plenoptic sensor according to examples of the present disclosure.

FIG. 9 shows a test setup for the demonstration of the ToF using fabricated thin Si waveguide according to examples of the present disclosure. The reflected signal at 5 m range was successfully measured.

FIG. 10 shows the measured signal versus target distance up to 5 m range according to examples of the present disclosure.

FIG. 11 shows spatial coverage with a ten-element array with five periods (550-, 500-, 450-, 417- and 400-nm) and two perpendicular orientations. Five pixels with grating lines oriented in the x-direction and five oriented in the y-direction. The axes are normalized to the height of the sensor above the detection spherical section (set by the time-of-flight). The overall coverage approximates a circle with a radius of hsinθᵢₗₗ=0.707 h where θᵢₗₗ=45° is the illumination half-angle. TE mode coupling is shown with solid lines, TM mode with dashed lines. The 417-nm period grating was chosen to be close to coupling at normal incidence for the TE mode, giving rise to the star-shaped response at normal incidence to the sensor.

### DETAILED DESCRIPTION

Exemplary aspects will now be described more fully with reference to the accompanying drawings. Examples of the disclosure, however, can be embodied in many different forms and should not be construed as being limited to the examples set forth herein. Rather, these examples are provided so that this disclosure will be thorough and complete, and will fully convey the scope to those skilled in the art. In the drawings, some details may be simplified and/or may be drawn to facilitate understanding rather than to maintain strict structural accuracy, detail, and/or scale. Reference will now be made in detail to the present teachings, examples of which are illustrated in the accompanying drawings. In the drawings, like reference numerals have been used throughout to designate identical elements. In the following description, reference is made to the accompanying drawings that form a part thereof, and in which is shown by way of illustration specific examples of practicing the present teachings. The following description is, therefore, merely exemplary.

### Grating Coupling to Planar Waveguide

Generally speaking, an integrated plenoptic device/people occupancy counting sensor for time-of flight (ToF) measurements based on grating-coupled-waveguide and angularly resolved detection is disclosed. Experimental results are presented for the plenoptic (angle of incidence and wavelength) sensor designed for maintaining personal privacy while performing occupancy detection via ToF measurements. In some examples, the sensor can be fabricated in an integrated-photonic foundry process. The goal is to fabricate an array of sensors with different gratings looking in many different directions and covering a large azimuth/altitude footprint, with standard microelectronic manufacturing enabling low-cost mass production. Unlike the photodetectors used in cameras or other lidar systems that accept light from a cone of incident directions, a grating coupler is used to filter the reflected light such that each detector receives light from a specific set of azimuthal (φ) and altitude (θ) angles and in a narrow wavelength range providing enhanced rejection of background illumination. Whereas traditional ToF systems look in a small number of directions and determine the distance to an object, combining the angle discrimination of an array of plenoptic devices with a ToF measurement allows the position of multiple objects to be determined, in effect a coarse 3D mapping. For a fixed wavelength (λ) and structure of the waveguide

$$( {n}_{mode}^{TE , TM} ) ,$$

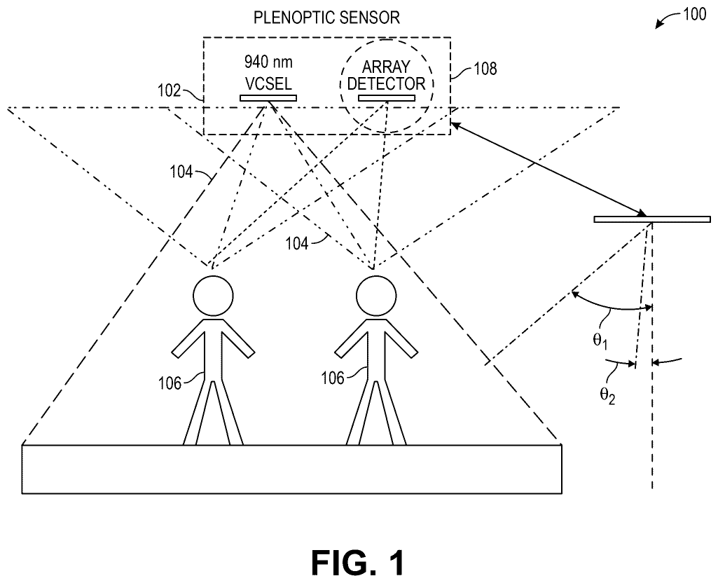

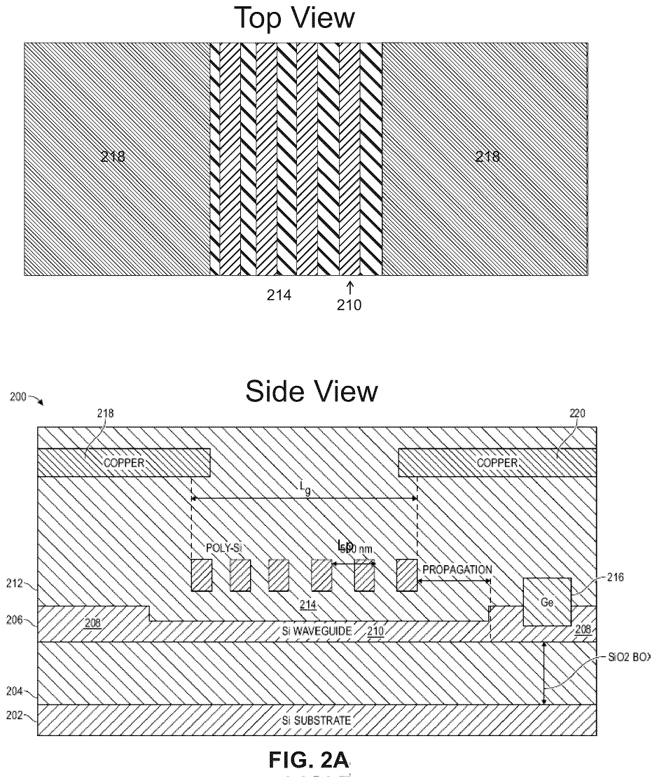

and the angles of altitude and azimuthal incidence (θ, φ) that are coupled into the waveguide are determined by the period of the grating (d). FIG. 1 shows a schematic of the system design 100 according to examples of the present disclosure. A vertical cavity surface-emitting laser (VCSEL) 102, such as a VCSEL that emits a 940 nm laser beam, emits light in a broad cone 104 that is reflected from an object 106, such as the head of a person, back towards an array detector 108, such as an array of plenoptic sensors, with different grating periods and orientations. Although FIG. 1 shows one VCSEL, the system design 100 can include one or more optical sources. For example, each of the one or more optical sources can be amplitude modulated and the plenoptic sensors 108 can provide information on a phase shift between a source modulation and reflected light to extract the ToF information. In another example, each of the one or more optical sources can comprise two orthogonally polarized sources modulated at different frequencies to provide additional identification based on the relative strengths of TE and TM coupling. In a further example, each of the one or more optical sources can be pulse modulated.

Light is coupled into the array detector 108 and is rejected by others, due to the varying phase matching constraints resulting from the different gratings. The coupled signal is detected by the array detector that includes a photodiode integrated with the waveguide that is then amplified by a transimpedance amplifier (TIA). The ToF distance determination can be either direct (using ns pulses) or indirect (phase shift of an amplitude-modulated CW signal). For occupancy counting, the sensor array and laser will be mounted on the ceiling; therefore, distance measurements and conical diffraction (where the wavevector of the reflected light onto the grating coupled waveguide is at an angle to the grating wavevector, e.g. to the perpendicular to the grating lines) are also considered here. The signal-to-noise ratio of the detector allows for accurate free-space measurements to be taken over a distance of a few meters, even when considering background noise sources such as sunlight or room illumination. The range will be set by eye-safety considerations, a range of ~5 m is demonstrated with a commercial laser source.

The coupling angles are determined by phase matching between the incident wavevector kₓ(θ, φ)=2π/λ sin θ cos φ; k_{y} (θ, φ)=2π/λ sin θ sin φ scattered by the grating, Δkₓ=m 2π/d, where λ is the source wavelength, d is the grating period, m is an integer (+1 for the experiments reported here), and the modal wavevector is

$$2 π / {λ}^{{n}_{mode}^{TE , TM} ( λ )} ,$$

and the x-direction is taken along the grating wavevector:

$${k}_{x} ( θ , ϕ ) = \frac{2 π}{λ} ( sin θ cos ϕ \pm m \frac{λ}{d} ) ; \qquad ( 1 )$$

$${{k}_{y} ( θ , ϕ ) = \frac{2 π}{λ} sin θ sin ϕ ; {k}_{x}^{2} ( θ , ϕ ) + {k}_{y}^{2} ( θ , ϕ ) = [ \frac{2 π}{λ} {n}_{mode}^{TE , TM} ( λ ) ) ]}^{2} .$$

In the limit of φ=0, these equations simplify to the more familiar grating equation,

$$sin θ \pm {m}^{λ {/}_{d}} = \pm {n}_{mode}^{TE , TM} ,$$

where the plus (minus) signs are for forward (backward) coupling. First, results are presented for φ=0 to establish the coupling properties; conical coupling (φ≠0) is then discussed. The modal indices

$${n}_{mode}^{TE , TM}$$

depend on the various material indices of refraction and on the transverse dimensions of the waveguide. This dependence is suppressed in the notation where only the wavelength dependence is explicit.

### Design and Simulation

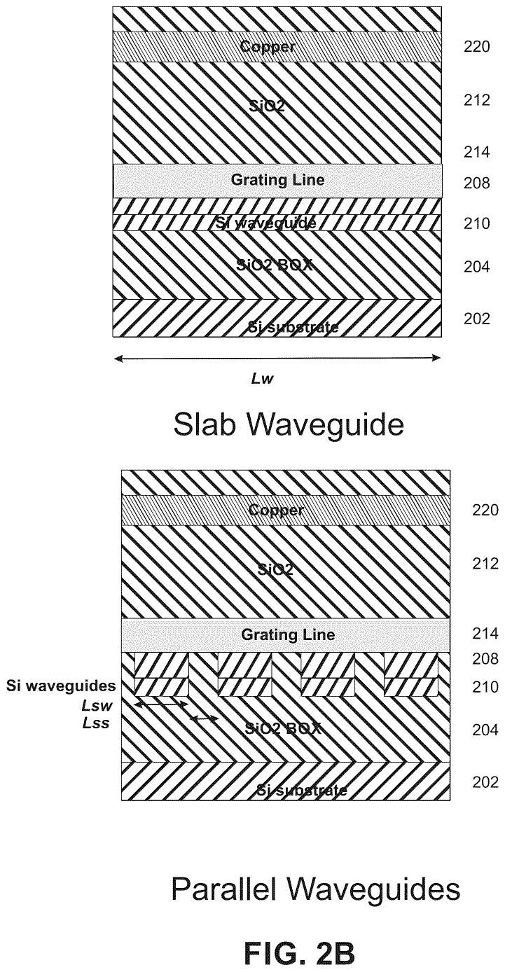

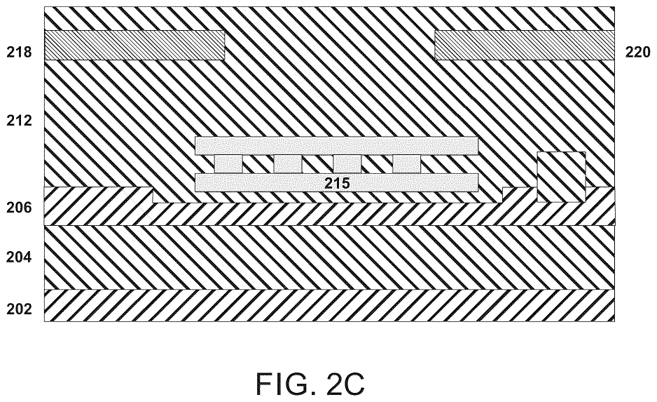

FIG. 2A shows both top down and side view schematics of a plenoptic device 200 based on a silicon-on-insulator (SOI) waveguide clad with SiO₂, a polycrystalline (poly-Si) grating structure and a Ge photodetector according to examples of the present disclosure. The plenoptic device 200 comprises a Si substrate 202. The plenoptic device 200 further comprises a first oxide (SiO₂ bottom oxide (BOX)) layer 204 formed on a top surface of the Si substrate 202. The plenoptic device 200 further comprises a Si waveguide 206 formed on a top surface of the first oxide (SiO₂ BOX) layer 204 with a first thickness 208 at a first end and a second end of the Si waveguide 206 and a second thickness 210 at a region between the first end and the second end, wherein the second thickness 210 is smaller than the first thickness 208. The plenoptic device 200 further comprises a collection area formed from a second oxide (SiO₂ layer 212 formed on a top surface of the Si waveguide 206. The second oxide (SiO₂) layer 212 comprises a poly-Si grating structure 214 having a total length given by L_{g} and spacing between grating elements of 500 nm from a first side of one grating element to a common first side of an adjacent grating element. The poly-Si grating structure 214 is formed above the region of the Si waveguide 206 having the second thickness 210. A Ge photodetector 216 is formed in a region between the Si waveguide 206 and the second oxide layer 212 in a region of the second end. Electrodes 218 and 220 are provided (connections not shown) to provide electrical communication to the plenoptic device 200. As shown in the top view, the grating lines extend across the width L_{w} of the device.

In FIG. 2A, the collection area formed and the Ge photodetector 216 of the plenoptic device 200 are integrated on chip and can be fabricated in a commercial silicon-on-insulator (SOI) integrated-photonics foundry process. A thinned silicon waveguide layer was chosen to reduce silicon absorption losses at the 940 nm design wavelength. Other variations including an un-thinned silicon waveguide layer and a silicon nitride waveguide core layer have been investigated. The refractive index of Si at 940 nm is 3.6+i1.37×10⁻³. The waveguide and gratings are comprised of Si and poly-Si, respectively. For a slab waveguide of width L_{w}>>The modal indices in the absence of the poly-Si grating are TE: 2.26+1×10⁻³ and TM: 1.54+4.2×10⁻⁵; the TE mode is more strongly confined in the silicon layer (higher modal index) and has a correspondingly higher loss. The 1/e propagation length for the TE (TM) mode is ~150 μm (3.6 μm) while the distance between the collection and detection is only ~15- to 30-μm, so propagation losses are negligible for the TM mode and relatively minor for the TE mode. For the present demonstration, the period of the grating is 500 nm, with a line:space ratio of 0.32. Both different grating periods and different line:space ratios are possible. A heteroepitaxial Ge absorption region, partially embedded in the silicon layer is used to detect the 940 nm waveguide mode power. Shielding to prevent direct illumination of the detector is incorporated into the electrodes 218 and 220 and further to additional back-end-of-the-line metallization layers (not shown). It is of course important to keep a line-of-sight from the top of the integrated circuit chip to the grating coupler.

FIG. 2B shows end on views for a cut through the middle of the collection region for two cases according to examples of the present disclosure. A wide area slab waveguide with width L_{w}, and a set of parallel waveguides with widths. FIG. 2C shows a side view schematic of the plenoptic device with a multi-layer photonic crystal coupling structure in place of the simple grating of FIG. 2A.

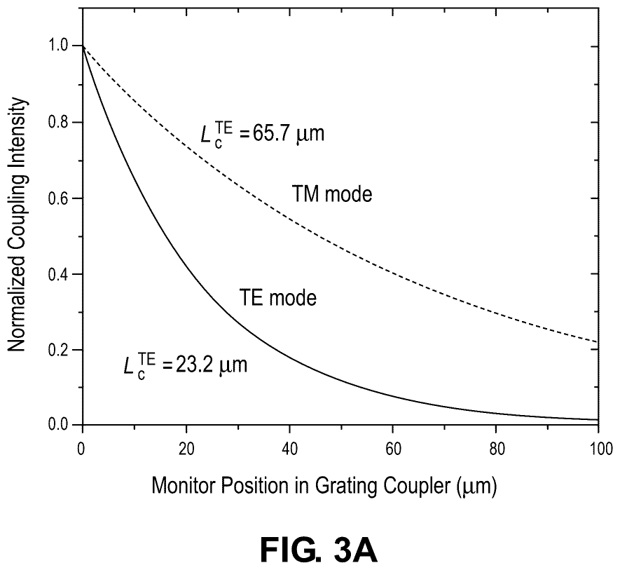

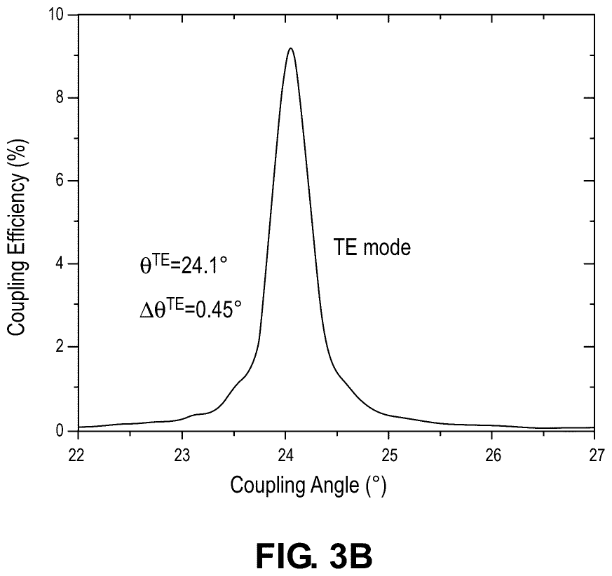

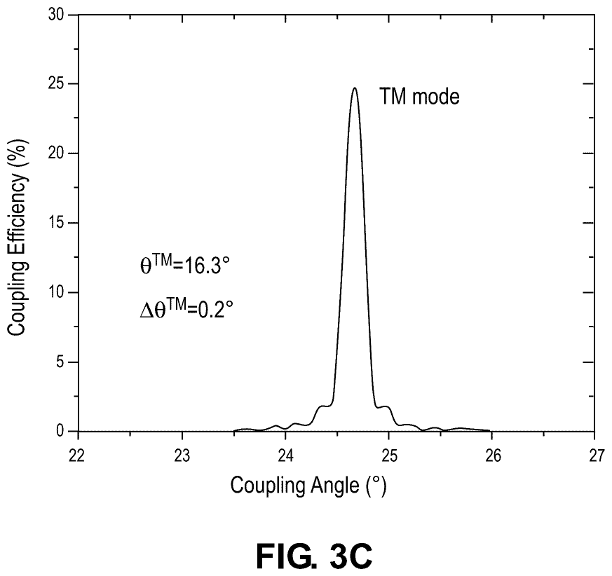

The finite-difference time-domain (FDTD) simulation results for the collection of incident illumination are presented in FIG. 3. For the current parameters, the TE mode couples in the forward direction and the TM mode, with a very different modal index, couples in the backward direction, negative coupling angle. Four factors influence Δθ, the angular width of the coupling: the coupling length L_{c}, the 1/e length over which light is coupled out of the waveguide by the grating; the coupling angle, θ; the physical length of the collection area grating parallel to the grating lines, L_{g}; and the extent of the illumination spot, Lₛ. In the plenoptic measurement outlined in FIG. 1, the illumination is always much wider than the device, Lₛ>>L_{g}, so this factor is can be neglected.

For simulation purposes, the laser source is treated as an ideal plane wave. For the case L_{c}≥L_{g}, the angular lineshape is a sinc (sin(x)/x) function and the angular width is dominantly inverse to L_{g}. When the L_{g}≥4L_{c}, the acceptance angle is set by the coupling length and the altitude angle and the lineshape is Lorentzian:

$$Δ θ = \frac{λ}{2 π {L}_{c} cos θ} , \qquad ( 2 )$$

Here Δθ is the acceptance angle, θ is the coupling angle and L_{c} is the coupling length. The wavelength range for coupling at a fixed angle is closely related, and will be important for broadband background rejection as discussed below:

$$Δ λ = \frac{λ d}{2 {π L}_{c} [ 1 - d {(}^{\partial {n}_{mode / \partial λ}} ) ]} = \frac{dΔθ cos θ}{[ 1 - d {(}^{\partial {n}_{mode / \partial λ}} ) ]} . \qquad ( 3 )$$

FIG. 3A, FIG. 3B, and FIG. 3C show simulation result of coupling length and angular intensity in FIG. 3A, for TE in FIG. 3B, and TM mode coupling in FIG. 3C, according to examples of the present disclosure. FIG. 3A shows the decay of the signal power in the waveguide as a function of propagation length from the start of the grating. The collection area length was 250 mm, sufficiently long that the angular width is inversely proportional to the coupling length. The 250 mm TE mode collection length is more than 10× the simulated coupling length, so the resolution is dominated by L_{c}. The angular resolution of the TM mode is narrower than that for the TE mode as a result of the longer L_{c}; there is some contribution to the angular resolution from the finite grating dimension (L_{g}) as well as from the coupling length.

In FIG. 3A, the numerical simulation of L_{c} was performed by launching a mode under the grating and monitoring the decay of the modal intensity as power is radiated into free space. This is equivalent to the length for which additional energy is coupled into the waveguide mode under uniform irradiation. Any energy coupled in for longer grating dimensions is reradiated before it reaches the propagation region. The TE coupling is in the forward direction, while the lower modal index TM mode is backward coupled. The results for the angular width are consistent with the L_{c} calculations of Eq. (2). For an extended source, such as reflection from a person, the total intensity coupled into the waveguide mode is proportional to the product of the peak efficiency (11%-TE; 23%-TM) and the angular acceptance Dq. This product is 0.066 (TE) and 0.05 (TM), roughly comparable for the two polarizations.

### Measurement Results and Analysis

### Coupling and Acceptance Angles

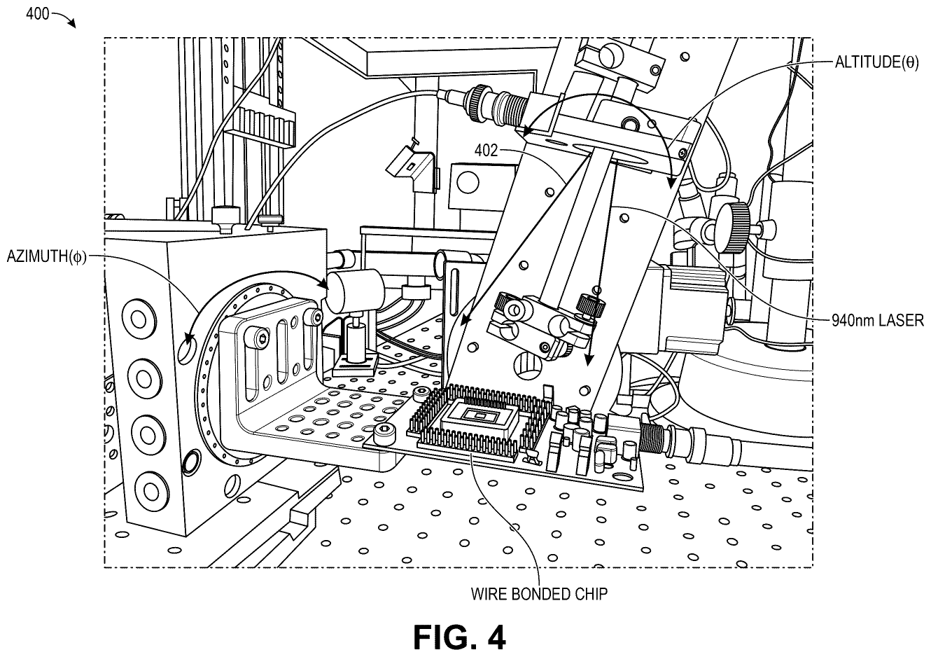

FIG. 4 shows the measurement arrangement 400 according to examples of the present disclosure. An Osram VCSEL 940 nm laser array (PLPVQ940A) 400 was used as the source for the angular scan. The emission area of the device is ~0.25 mm². The laser was positioned 12 cm above the device along the altitude axis. The azimuth angle is 0° for the coupling angle measurements. The illumination field of the laser is 65° along the horizontal axis and 78° along the vertical axis. The arm of the measurement instrument is rotated to find the coupling angle. The azimuth angle is then swept in 5° increments to monitor the conical diffraction variations.

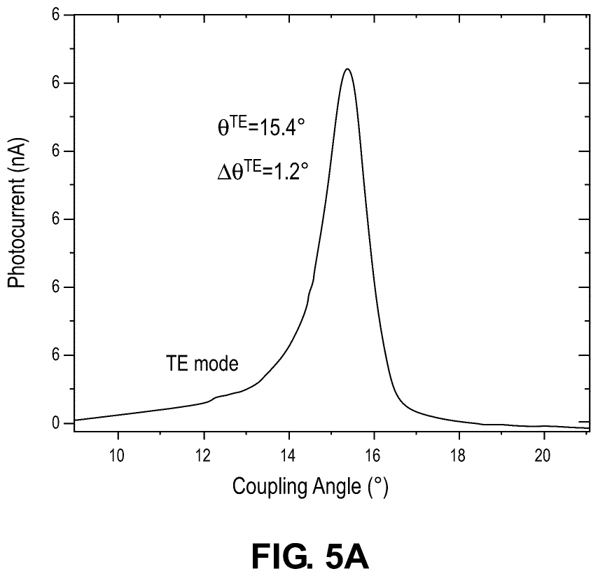

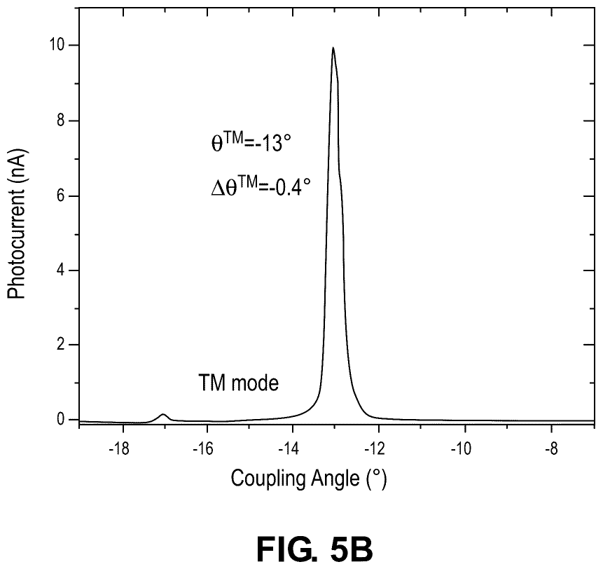

FIG. 5A and FIG. 5B shows the φ=0 measurement of the (a) TE and (b) TM mode coupling angles with a 500-nm period poly-Si grating and a thinned SOI waveguide with the detector at 0 V bias according to examples of the present disclosure. The grating height (along the grating lines) was 100 μm and the power density incident on the chip before coupling was 26 μW/mm².

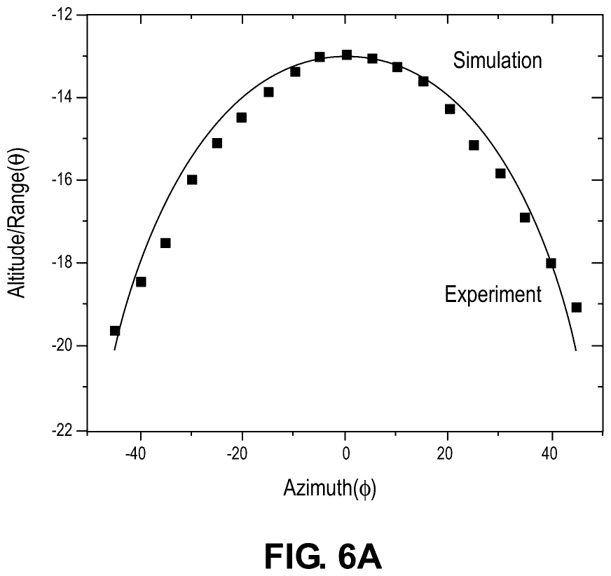

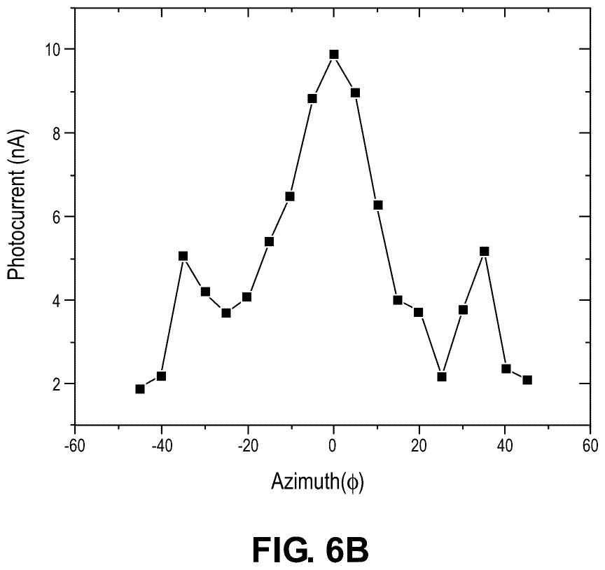

FIG. 6A and FIG. 6B show TM angular response for conical geometry and photocurrent variation with azimuthal angle, respectively, according to examples of the present disclosure.

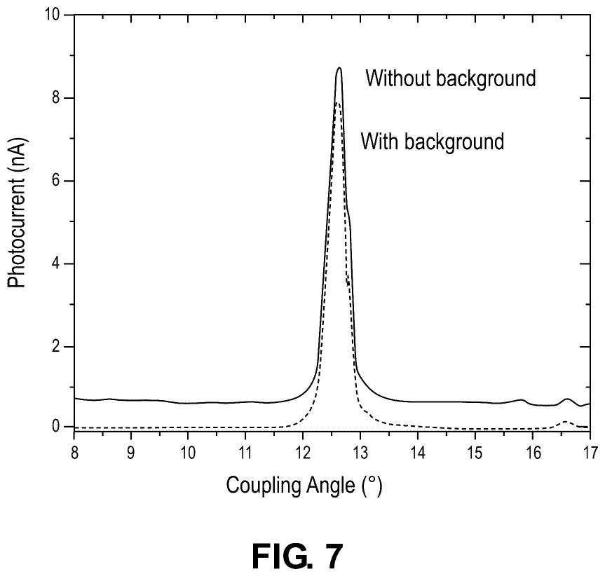

FIG. 7 shows signal variation without and with incandescent light irradiation according to examples of the present disclosure.

To fit these experimental results, the effective refractive index n_{eff} was adjusted from 1.62 to 1.65, this could be due to manufacturing variations in the thickness of the SOI waveguide or the grating period. The finite size of the laser array contributes about 0.2° to the acceptance angles. The results are in reasonable agreement with the simulation.

### Conical Coupling Angles

As devices will be assembled on the ceiling, the illumination will be incident on the grating in a conical geometry, where the in-plane component of the incident beam direction, depending on the position of the scatterer, is at an arbitrary angle to the grating k-vector. It is very important to understand the angular response for an arbitrary combination of (φ, θ). FIG. 6A and FIG. 6B present the angular response and photocurrent for TM-mode coupling in a conical geometry, respectively, according to examples of the present disclosure. The power density is 26×cos(φ) μW/mm². φ=0 corresponds to light incident along the grating k-vector. As a result of mechanical issues, the angular response and photocurrent are not perfectly symmetric. The phase-matching calculation is in good agreement with the experimental results. When φ=0, the lowest coupling angle −13° and the highest photocurrent are obtained. As the azimuth is increased, the coupling angle increases. The coupling angle varies from −13° to −19° with the azimuth angle varying from 0° to 45°. The results are in good agreement with the angles calculated from Eq. (1). The photocurrent decreases faster than 1/cos(φ) since the mode propagates at an angle to the detector which is parallel to the grating lines and more and more of the collection area is lost as increases.

### Immunity to Background Illumination

Many time-of-flight systems are plagued by broadband background illumination, for example from sunlight (window) or room illumination, that interferes with the measurements. In contrast to direct measurement approaches, the waveguide coupling approach is sensitive only to a narrow wavelength band [Δλ~dΔθ^{TM} cosθ^{TM}~1.7 nm] rejecting most of the broadband background illumination.

Sunlight and incandescent room lighting have high irradiance around the 940 nm design wavelength, so interference from these sources must be considered. Most white LEDs are composed of blue LEDs along with a yellow phosphor. The peaks of the spectrum are at 450 nm and 550 nm, and the interference due to LED lighting is generally negligible. Here, we present result for co-illumination with a 940 nm laser and an incandescent lamp source (500 lumens). The incandescent light color temperature is 2700K and it is positioned 21 cm away from the chip. Since this is an extended source, the incident angle is over a range of −13°±1.5°. The power density of the incandescent light on the chip is 13 μW/mm², while the TM power density of the laser is 20.8 μW/mm². FIG. 7 shows the TM measurement results with and without the incandescent light irradiance. Compared to the curve without the background, the noise baseline increases to ~0.9 nA as a result of the broadband continuum emission of the incandescent lamp within the bandwidth of the grating coupler. Without the grating filtration, the signal from the broadband incandescent lamp would saturate the detector and totally swamp the received signal. The signal amplitude is unaffected and is simply additive to the background. The acceptance angle remains at 0.4° for both data sets. The background noise from sunshine and/or incandescent room illumination does not influence the accuracy of the plenoptic angle measurement.

### Demonstration of Indirect Time-of-Flight Measurements

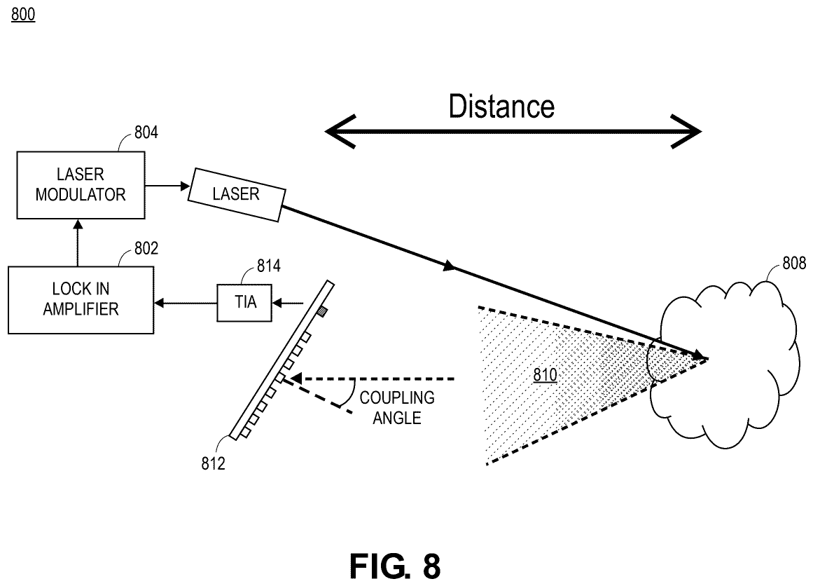

FIG. 8 shows a schematic of a test setup 800 using an indirect ToF measurement using the developed plenoptic sensor according to examples of the present disclosure. This plenoptic detector can be used in either direct (pulse delay metric) or indirect (phase shift metric) ToF sensors. In this example, an indirect approach was chosen to demonstrate a practical use of plenoptic device in a ToF application as shown in FIG. 8. A commercial lock-in amplifier 802 (Moku:Lab from Liquid Instruments) was used, using ToF sensor 812 that outputs a signal through transimpedance amplifier (TIA) 814, the phase/amplitude of the reflected beam 810 from a target object 808 compared to the reference source, which drives a 940 nm laser 806 using a laser modulator 804.

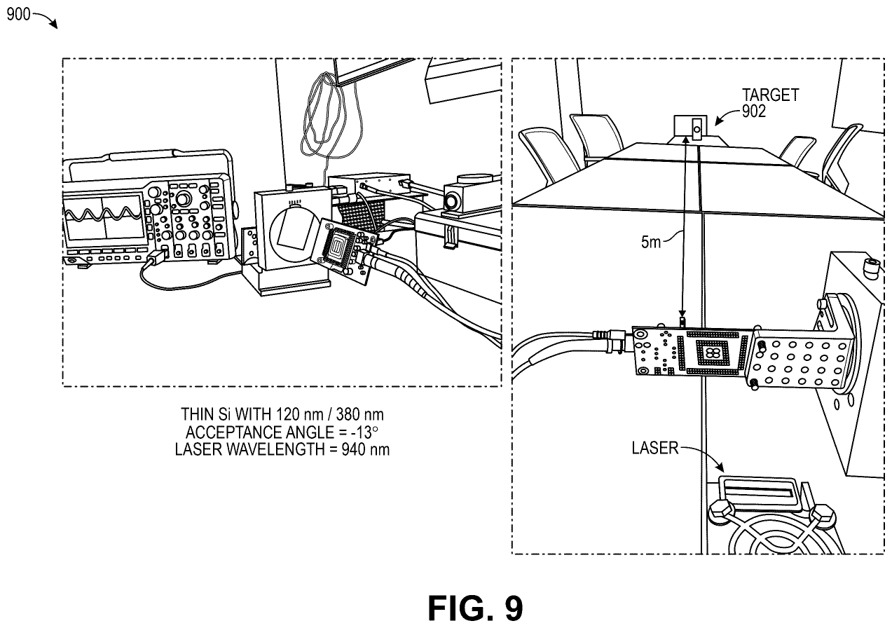

FIG. 9 shows a photograph of the test setup 900 for the demonstration of the ToF using fabricated thin Si waveguide according to examples of the present disclosure. As shown in FIG. 9, a printed circuit board (PCB, 950) was designed with a socket to hold the test chip with foundry-fabricated plenoptic devices (940). The PCB is tilted ~13° from the vertical to receive the retroreflected light. The PCB also includes an ultra-low noise (250 fA/√Hz) and high gain (10 MΩ) transimpedance amplifier (TIA, 945) The detector was operated a zero bias to eliminate dark current noise. A collimated laser source 910 is located just behind the detector. A diffuse retroreflector (piece of white paper, 902) was mounted at varying distances from the laser and detector (in the figure the distance is 5 m). The reflected signal at 5 m range was successfully measured. While the target 902 was placed at various distances, the phase of the reflected signal was measured using a lock-in amplifier (not shown) and monitored with an oscilloscope 955. The PCB holding the chip is mounted on a rotation stage, so that its angle can be adjusted to accept the reflected light at the coupling angle set by the plenoptic device under test as shown in FIG. 9.

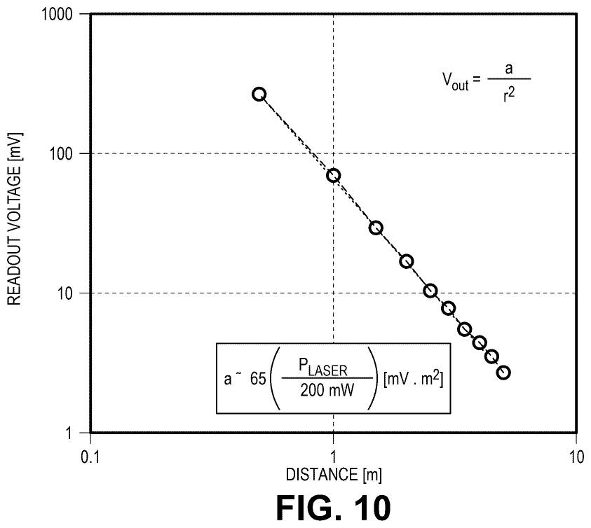

The reflected signal at a 5 m range was successfully measured. FIG. 10 illustrates the measured signal, when the target is placed at various distances from the source/detector. The signal versus distance clearly follows the expected 1/R² relationship. The device under the test had the same structure as the device reported in FIG. 5A, FIG. 5B, FIG. 6A, FIG. 6B, and FIG. 7 with a thinned Si waveguide, with a 100 mm collection height, and a 500 nm period poly-Si coupling grating with a coupling angle of about −13°. The lock-in carrier frequency was 10.61 kHz and the average laser power was 200 mW. This frequency was chosen to accommodate the TIA bandwidth, and is too low to provide the necessary resolution for room occupancy distance measurements. The maximum range depends on several parameters including laser power, detector noise, TIA noise, as well as system bandwidth. Our measurement was limited by the background noise of the TIA. Avalanche detection, which boosts both the signal and the detector noise making the TIA noise less significant, will lead to a further extension in the range.

The measured data from this experiment provides a baseline that will be used to scale the design for commercially viable ToF sensor application, where the laser power will be reduced to an eye-safe range. The areas of improvement include collection area optimization, as well as APD optimization, and TIA integration.

### Discussion and Conclusion

Grating-coupled plenoptic detectors provide angle of incidence information. These devices are readily integrated in silicon photonics and have myriad applications in automotive control, environmental efficiency and energy saving, manufacturing, and healthcare. The integrated devices demonstrated here were fabricated in a commercial silicon-on-insulator integrated photonics 90 nm process. For a fixed 940 nm wavelength source, we have demonstrated angular sensitivities of 0.4° (1.2°) for TM (TE) light incident on a SOI-based waveguide with a poly-Si grating. The impact of conical illumination has been analyzed and demonstrated. Importantly, the waveguide configuration provides a narrow-band filtering function that makes these devices insensitive to broadband background illumination such as sunlight. An indirect ToF measurement with a range of up to 5 m has been demonstrated.

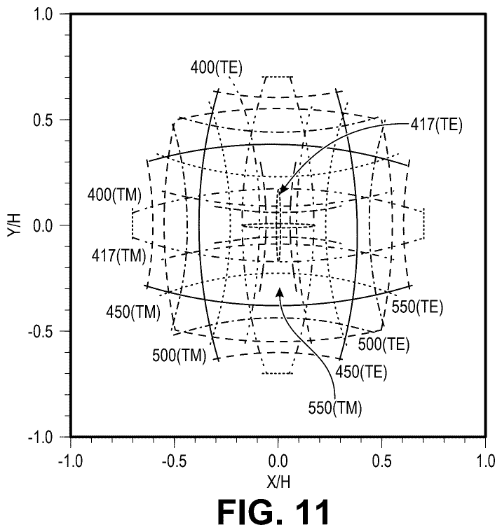

FIG. 11 shows spatial coverage with a ten-element array with five periods (550-, 500-, 450-, 417- and 400-nm) and two perpendicular orientations (a total of 10 grating coupled waveguides. Five pixels with grating lines oriented in the x-direction and five oriented in the y-direction. The axes are normalized to the height of the sensor above the detection spherical section (set by the time-of-flight). The overall coverage approximates a circle with a radius of hsinθᵢₗₗ=0.707 h where θᵢₗₗ=45° is the illumination half-angle. TE mode coupling is shown with solid lines, TM mode with dashed lines. The 417-nm period grating was chosen to be close to coupling at normal incidence for the TE mode, hence the star-shaped response at normal incidence to the sensor.

The next demonstration step is to fabricate an array with different period grating and different orientations. An initial system concept is shown in FIG. 11 which shows the spatial coverage with a 10-element array with five different period gratings oriented along orthogonal x- and y-directions. Detectors, parallel to the grating lines, are assumed on both sides of the collection area. TE-mode coupling is represented with solid lines, TM-mode coupling with dashed lines. The 417 nm period grating was chosen to provide approximately normal incidence coupling to the TE mode, resulting in the star-shaped response near (0,0). The overall response approximates the illumination circle with a radius of 0.707 h where h is the height above the observation plane assuming a 45° ½-angle illumination cone. Additional gratings with intermediate periods will provide additional spatial resolution, if necessary. Coincidence detection, and continuity monitoring with multiple sensors at the same distance from the source will provide additional signal processing opportunity for confirming position and movement as people circulate in the room. The scale of the figure is normalized to the height from the sensor. For example, for a sensor mounted in an office space, assuming a 3 m ceiling height, the illuminated region on the floor corresponds to ~2 m. For a person standing under the sensor, the distance to the ceiling is ~1 m, and the circle roughly corresponds to a 0.7 m diameter, while the extended reflection occupies 0.3 m, so this limited number of ToF sensors provides more than adequate resolution. For a larger conference venue, with for example a 7-m high ceiling, the diameter for a standing person is ~3.5 m and additional resolution (intermediate grating periods) will be required.

Additionally, integration of the detection and analysis electronics, will simplify the overall system. Fabrication of arrays of devices with different grating periods and orientations will provide a low-resolution 3D mapping capability and to demonstrate indoor lidar with a co-packaged 940 nm source. This will provide a low-cost manufacturable solution that will enable many indoor lidar applications.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

The examples set forth herein represent the necessary information to enable those skilled in the art to practice the embodiments and illustrate the best mode of practicing the embodiments. Upon reading the description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A time-of-flight (ToF) sensor integrated on a Si substrate based on a periodic-structure-coupled waveguide propagation and detection to provide immunity from ambient light comprising:
one or more optical sources to illuminate a region of interest;
one or more periodic-structure-coupled waveguides to collect light reflected from objects within the region of interest and propagating in a narrowband of altitude and azimuth (θ, φ) angles determined by one or more parameters of the periodic-structure-coupled waveguides;
a photon detector integrated with each periodic-structure-coupled waveguide to provide an electrical current proportional to the light coupled into the periodic structure-coupled waveguide;
a shield for shielding that is incorporated into metal interconnect layers of the integrated ToF sensor to shield the detectors from direct illumination; and
a first electronics comprising a transimpedance amplifier (TIA) to amplify the electrical current and interface with a second electronics that provides ToF information for each detector.

2. The ToF sensor of claim 1, wherein each periodic-structure-coupled waveguide is a broad area waveguide extending across the collection area.

3. The ToF sensor of claim 1, wherein each periodic-structure-coupled waveguide is partitioned into a parallel array of narrower waveguides.

4. The ToF sensor of claim 1, wherein each of the one or more optical sources are amplitude modulated and the second electronics provides information on a phase shift between a source modulation and reflected light to extract the ToF information.

5. The ToF sensor of claim 1, wherein each of the one or more optical sources comprises two orthogonally polarized sources modulated at different frequencies to provide additional identification based on the relative strengths of TE and TM coupling.

6. The ToF sensor of claim 1, wherein each of the one or more optical sources are pulse modulated.

7. The ToF sensor of claim 1, wherein the second electronics provides information on a time delay between source pulse and arrival of reflected light to extract the ToF information.

8. The ToF sensor of claim 1, wherein each of the one or more optical sources comprises two orthogonally polarized sources pulsed at different times to provide additional identification based on the relative strengths of TE and TM coupling.

9. The ToF sensor of claim 1, wherein the photon detector is a semiconductor detector comprising Si, Ge, InAsP or ternary or quaternary III-V alloy that is epitaxially grown on the Si and integrated with the periodic-structure-coupled waveguide.

10. The ToF sensor of claim 1, wherein the photon detector comprises a PIN detector or an avalanche photodiode (APD) detector.

11. The ToF system of claim 1, wherein the source is configured to illuminate a line and sweep the line across a field of view and the periodic-structure-coupled waveguides are configured to collect light reflected from objects within the region of interest in a narrowband of altitude and azimuth (θ, φ) angles determined by one or more parameters of the periodic-structure-coupled waveguides where the narrowband altitude and azimuth angles are oriented to collect reflected light along a line perpendicular to the illumination.

12. A time-of-flight (ToF) sensor based on grating-coupled waveguide propagation and detection to provide immunity from ambient light comprising:
one or more optical sources to illuminate a region of interest;
one or more silicon-on-insulator (SOI) grating-coupled waveguides to collect light reflected from objects within the region of interest and propagating in a narrowband of altitude and azimuth (θ, φ) angles determined by one or more coupling parameters of the periodic-structure-coupled waveguide;
a germanium photon detector integrated with each periodic-structure-coupled waveguide to provide an electrical current proportional to the light coupled into the periodic-structure-coupled waveguide;
a transimpedance amplifier (TIA) that amplifies the electrical current and interface with electronics that provides ToF information; and
one or more metal shields that prevent direct illumination of each detector.

13. The ToF sensor of claim 12, wherein the wherein each SOI periodic-structure-coupled waveguide comprises a substrate layer, a SiO₂ layer formed on to a top surface of the substrate layer, a Si waveguide layer formed on a top surface of the SiO₂ layer, a SiO₂ cladding layer atop the Si waveguide layer, a polycrystalline silicon periodic structure formed on a top surface of the Si waveguide layer, and additional dielectric layers above the periodic structure with a line-of-sight path from the top of the TOF sensor to the periodic-coupling structure.

14. The ToF sensor of claim 12, wherein the periodic structure formed on a top surface of the Si waveguide layer is one of a grating or a photonic crystal.

15. The ToF sensor of claim 12, wherein the waveguide is a broad area waveguide.

16. The ToF sensor of claim 12, wherein the waveguide layer comprises an array of parallel waveguides.

17. The ToF sensor of claim 12, wherein each of the one or more optical sources are amplitude modulated and the second electronics provides information on a phase shift between a source modulation and reflected light to extract the ToF information.

18. The ToF sensor of claim 12, wherein each of the one or more optical sources comprises two orthogonally polarized sources modulated at different frequencies to provide additional identification based on the relative strengths of TE and TM coupling.

19. The ToF sensor of claim 12, wherein each of the one or more optical sources are pulse modulated and the electronics provide information on the time delay between the source pulse and the arrival of reflected light to extract ToF information.

20. The ToF sensor of claim 12, wherein each of the one or more optical sources comprises two orthogonally polarized sources pulsed at different times to provide additional identification based on the relative strengths of TE and TM coupling.
